(19) United States
(12) Patent Application Publication
(10) Pub. No.: US 2025/0052147 A1
(43) Pub. Date: Feb. 13, 2025

(54) OFFSET WELL IDENTIFICATION AND PARAMETER SELECTION

(71) Applicant: Schlumberger Technology Corporation, Sugar Land, TX (US)

(72) Inventors: Prashanth Pillai, Pune (IN); Maurice Ringer, London (GB); Purnaprajna Mangsuli, Pune (IN); Vladimir Skvortsov, Moscow (RU)

(21) Appl. No.: 18/720,793

(22) PCT Filed: Jan. 30, 2023
(86) PCT No.: PCT/US2023/011808

§ 371 Date: Jun. 17, 2024

Related U.S. Application Data
(60) Provisional application No. 63/305,072, filed on Jan. 31, 2022.

(51) Int. Cl. E21B 47/12; E21B 44/02; G06N 20/00

(52) U.S. Cl. CPC E21B 47/138; E21B 44/02; G06N 20/00; E21B 2200/22

(57) ABSTRACT

A method includes receiving historical well data comprising trajectories, performance data, and one or more drilling parameters for a plurality of wells, clustering at least a portion of the plurality of wells into a plurality of clusters based on the trajectories, using a machine learning model, receiving trajectory data for a subject well, identifying one of the clusters based on the trajectory data of the subject well, using the machine learning model, selecting one or more of the plurality of wells, or one or more sections thereof, in the cluster that was identified based on the performance data associated with the one or more of the plurality of wells or the portion thereof, and visualizing the selected one or more of the plurality of wells or one or more sections thereof.

### CROSS-REFERENCE TO RELATED APPLICATIONS

This application claims priority to U.S. Provisional Patent Application having Ser. No. 63/305,072, which was filed on Jan. 31, 2022, and is incorporated herein by reference in its entirety.

### BACKGROUND

The cost of field exploration and well development for oil reserves at least partially depends on the rig cost and the field operator cost during a well drilling phase. That is, the cost associated with drilling is product cost dependent and also dependent on the time spent using the rig equipment. Therefore, one goal of an upstream oil company is to reduce the total drilling time spent, e.g., by reducing non-productive activities (non-productive time or NPT) where possible. One way to achieve this is through identification of similar wells from past drilling ventures, and leveraging the experience gained in such historical ventures into a new project.

However, the amount of information available from such past drilling ventures is vast, which can make identifying relevant and/or helpful information difficult. Much of the available information may not be relevant to a specific new well. Accordingly, drilling planners may spend large amounts of time sifting through offset well data to identify wells/sections with similar properties and drilled in similar conditions as a planned well.

### SUMMARY

Embodiments of the disclosure include a method including receiving historical well data comprising trajectories, performance data, and one or more drilling parameters for a plurality of wells, clustering at least a portion of the plurality of wells into a plurality of clusters based on the trajectories, using a machine learning model, receiving trajectory data for a subject well, identifying one of the clusters based on the trajectory data of the subject well, using the machine learning model, selecting one or more of the plurality of wells, or one or more sections thereof, in the cluster that was identified based on the performance data associated with the one or more of the similar wells or the portion thereof, and visualizing the selected one or more of the similar wells or one or more sections thereof.

Embodiments of the disclosure include a non-transitory computer-readable medium storing instructions that, when executed by at least one processor of a computing system, cause the computing system to perform operations, the operations including receiving historical well data comprising trajectories, performance data, and one or more drilling parameters for a plurality of wells, clustering at least a portion of the plurality of wells into a plurality of clusters based on the trajectories, using a machine learning model, receiving trajectory data for a subject well, identifying one of the clusters based on the trajectory data of the subject well, using the machine learning model, selecting one or more of the plurality of wells, or one or more sections thereof, in the cluster that was identified based on the performance data associated with the one or more of the plurality of wells or the portion thereof, and visualizing the selected one or more of the plurality of wells or one or more sections thereof.

Embodiments of the disclosure include a computing system including one or more processors, and a memory system comprising one or more non-transitory computer-readable media storing instructions that, when executed by at least one of the one or more processors, cause the computing system to perform operations. The operations include receiving historical well data comprising trajectories, performance data, and one or more drilling parameters for a plurality of wells, clustering at least a portion of the plurality of wells into a plurality of clusters based on the trajectories, using a machine learning model, receiving trajectory data for a subject well, identifying one of the clusters based on the trajectory data of the subject well, using the machine learning model, selecting one or more of the plurality of wells, or one or more sections thereof, in the cluster that was identified based on the performance data associated with the one or more of the plurality of wells or the portion thereof, and visualizing the selected one or more of the plurality of wells or one or more sections thereof.

Thus, the computing systems and methods disclosed herein are more effective methods for processing collected data that may, for example, correspond to a surface and a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for drilling, according to an embodiment.

FIGS. 3A and 3B illustrate a flowchart of a method for training a machine learning model, e.g., for selecting one or more drilling parameters, according to an embodiment.

FIGS. 4A and 4B illustrate a flowchart of a method for implementing a trained machine learning model, e.g., for selecting one or more drilling parameters, according to an embodiment.

FIGS. 5A and 5B illustrate normalized, clustered, well and/or section trajectories, according to an embodiment.

FIG. 6 illustrates a plot of depth versus time for a target well against a cluster of other wells, according to an embodiment.

FIG. 7 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

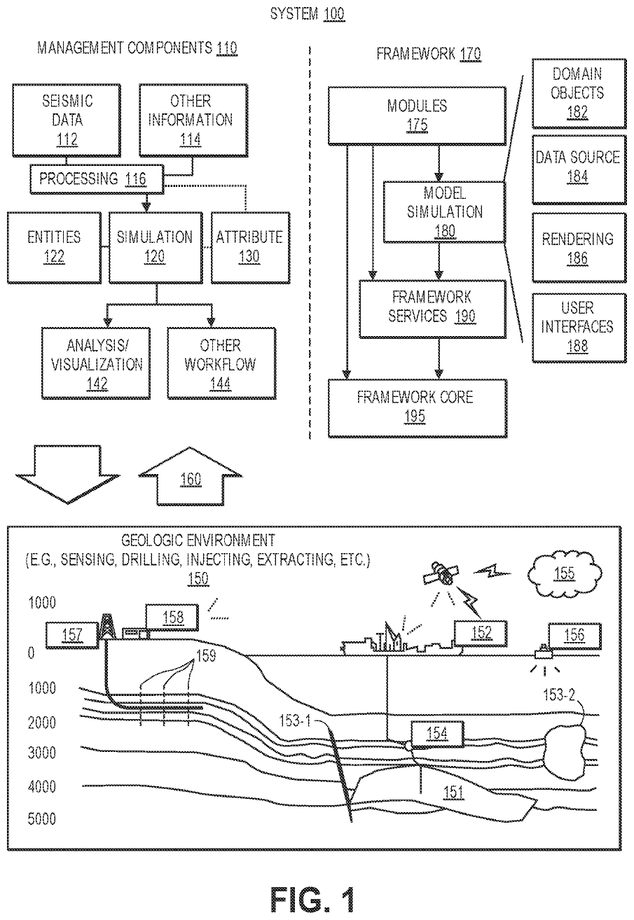

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFTR .NET® framework (Redmond, Washington), which provides a set of extensible object classes. In the. NETR framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEANR framework environment (Schlumberger Limited, Houston, Texas) allows for integration of add-ons (or plug-ins) into a PETREL® framework workflow. The OCEANR framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEANR framework where the model simulation layer 180 is the commercially available PETREL® model-centric software package that hosts OCEANR framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEANR framework. As an example, a workflow may include one or more worksteps that access a module such as a plug-in (e.g., external executable code, etc.).

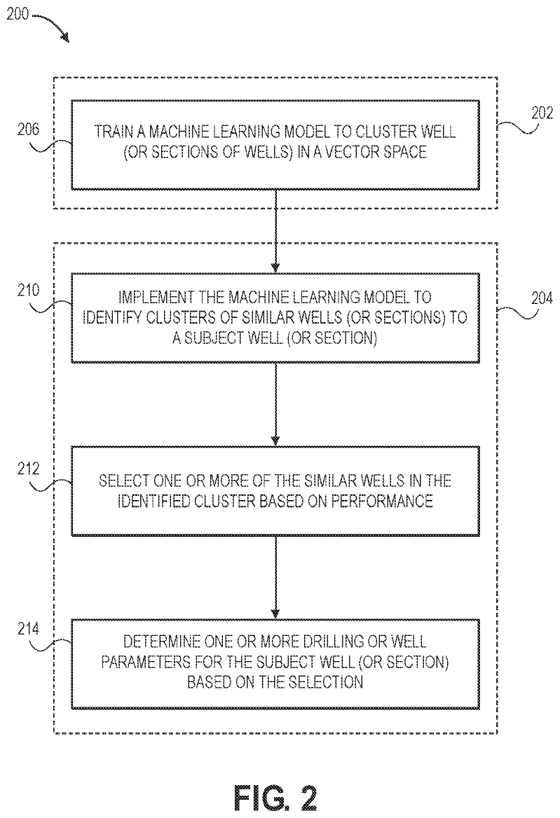

FIG. 2 illustrates a flowchart of a method 200 for drilling a subject well, according to an embodiment. The method 200 may include a training phase (or “stage”) 202 and an implementation phase (or stage) 204. In the training phase 202, a machine learning model may be trained to “cluster” (e.g., group) wells and/or sections of wells in a vector space, as at 206. This will be described in greater detail below, but by way of introduction, unsupervised machine learning may proceed by identifying patterns in a dataset and grouping the members of the dataset according to those patterns. In the present implementation, for example, the dataset may be wells or sections of the wells. Well sections refers to discrete intervals along the well, denoted, e.g., by a feature such as a specific casing diameter. The members of the dataset may be vectorized according to identified or “extracted” parameters. For example, the parameters may represent trajectory information (e.g., XYZ coordinates, azimuth, elevation, depth, delta change in depth, delta distance along an axis, etc.). The vectorized representations of the dataset members may then be plotted in a coordinate space, e.g., the vector space. Various different methods may then be employed to group the members of the dataset in the vector space, e.g., based on a distance therebetween. Examples of clustering techniques include K-means clustering. Further, the identification of the number of clusters may include techniques such as Elbow method, Average Silhouette method, and Gap statistic. The center of an individual one of the clusters may be referred to a centroid, and defined boundaries surrounding the centroid may be established (although the boundaries may be dynamic).

Having built the vector space and plotted the historical data therein, that is, trained the model, the method 200 may proceed to the model implementation phase 204. In this phase 204, the method 200 may include implementing the machine learning model to identify a cluster of wells (or sections thereof) that closely match a subject well (or section thereof), as at 210. For example, subsequent or new members of the dataset may be plotted in the same vector space as was used to “train” the model. The location of the newly-plotted dataset member may then permit a selection of a cluster, e.g., based on whether the location of the new dataset member is within a boundary of a centroid. In this manner, a group of one or more similar wells (or sections thereof) may be identified from the vector space used to train the model. Further, it will be noted that once the cluster is identified, the new dataset member may become part of the cluster for subsequent analysis, thereby serving to further train the model.

The method 200 may then proceed to selecting one or more of the similar wells (or sections) in the identified cluster based on the drilling performance that was realized while drilling the similar well, as at 212. The performance metrics may include, for example, maximum drill depth, rate of penetration (ROP), non-productive time (NPT), and/or drilling cost. Various other metrics may be used. An individual metric may be selected, e.g., by a user, to inform the selection of the similar wells/sections. In other embodiments, various combinations of performance metrics may be employed to, for example, generate a composite score that is used to rank the performance of wells, with a highest score (or score above a threshold, etc.) being used as selection criteria.

The method 200 may then employ the selected one or more similar wells to determine drilling and/or well (e.g., trajectory) parameters for the subject well, as at 214. In at least some embodiments, the one or more similar wells may be visualized, e.g., displayed on a computer display, which may illustrate one or more wells to the user, permitting the user to make parameter selections based at least in part on the displayed offset wells, selected using the machine learning model. For example, drilling parameters, well trajectory adjustments, equipment, etc., that was employed in a successful well or section (e.g., one in which NPT was relatively low, or ROP was relatively high) may be copied or implemented in a similar manner in the subject well, e.g., in an effort to replicate the performance of the high-performing offset well.

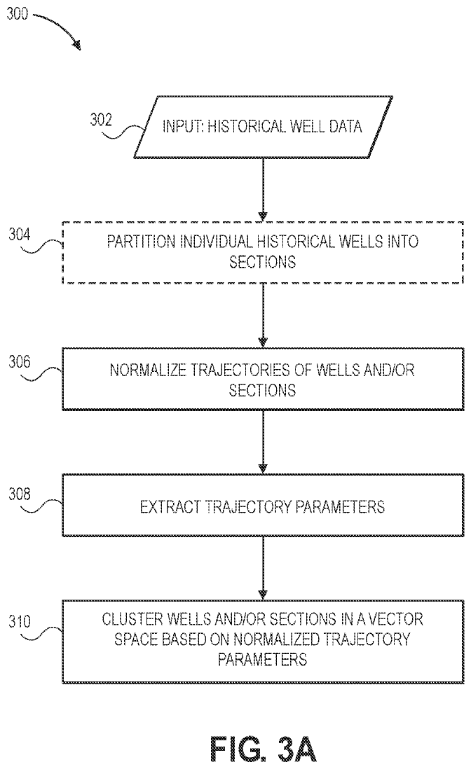

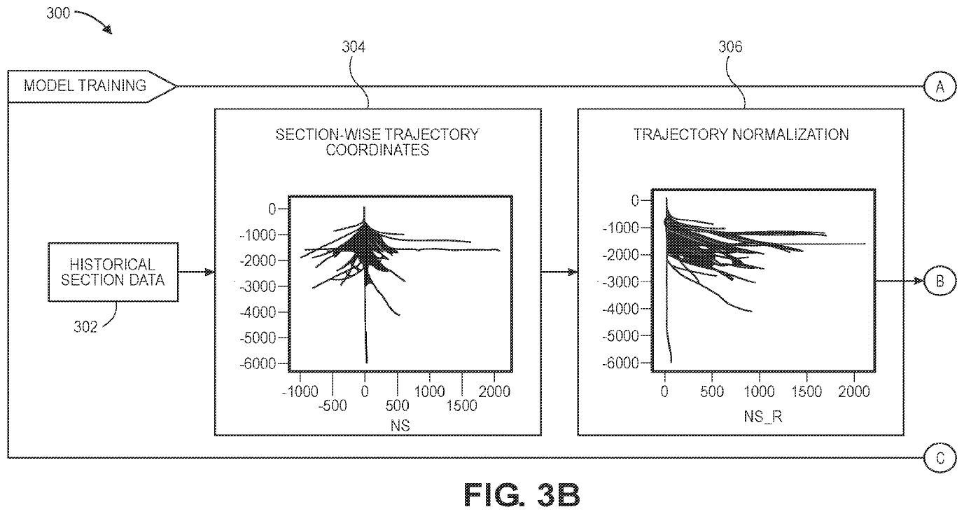

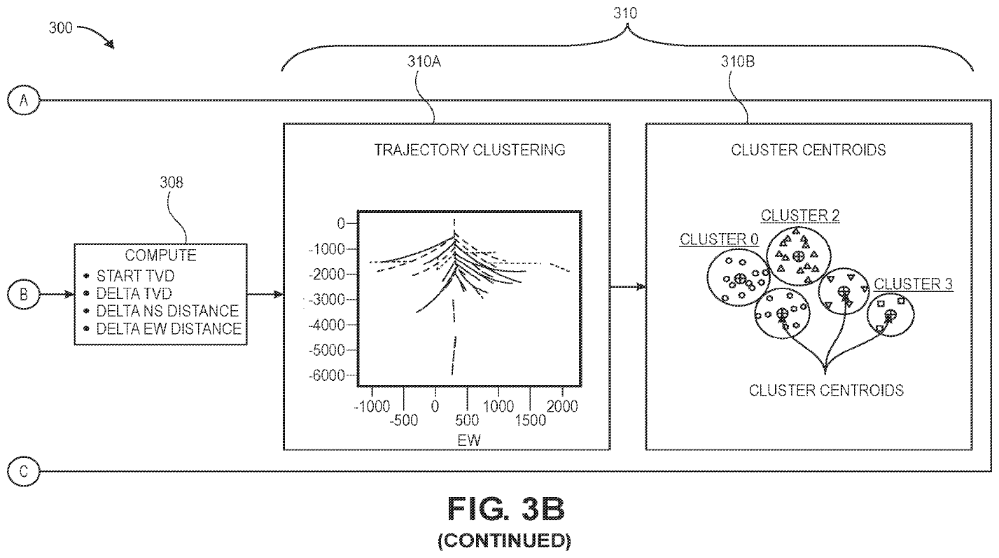

FIG. 3A illustrates a flowchart of a method 300 for training a machine learning model, according to an embodiment. The method 300 may be an embodiment of the training phase 202 discussed above. The method 300 may include receiving historical well data, as at 302. The historical well data may include data representing the individual wells, which may include individual section data and/or information about the trajectory of the well in total. The historical well data may include trajectory information such as XYZ coordinates, azimuth, elevation, etc.

In some embodiments, the historical wells may be partitioned into sections, as at 304, e.g., finite length, non-zero, depth intervals defined along the depth axis of individual wells. The intervals may be defined, for example, according to casing diameter that is used, e.g., with different sections employing different diameter casing. In other embodiments, other factors may be employed to establish section partitions. In still other embodiments, the wells may not be partitioned, but rather analyzed as a whole.

The method 300 may then include normalizing trajectories of the wells (and/or sections thereof, if partitioned at 304), as at 306. For example, trajectory normalization may include normalizing the coordinates to align north-south or east-west axes. Trajectory normalization may also include aligning drilling trajectory along the vertical section azimuth.

The method 300 may also include extracting trajectory parameters from the normalized trajectories, as at 308. This may occur after normalizing at 306. Parameters that may be extracted (e.g., calculated, measured, identified, etc.) include start vertical depth, delta change in vertical depth, change in distance in north-south axis, change in distance in east-west axis. Various other trajectory parameters may also be employed.

The extracted trajectory parameters, each associated with an individual well (or section thereof, if partitioned), may then be clustered in a vector space, as at 310. For example, a vector having a dimensionality that represents each of the extracted parameters may be generated for each individual well (or section thereof). In some cases, a given section or well may not include a value for each individual parameter. The vectorized trajectory data may then be plotted in the vector space, and clusters of dataset members (e.g., wells or sections) identified therein as discussed above, for example. The result may be a trained machine learning model including the vector space, which may permit rapid and automatic comparison of additional dataset members by implementation of the machine learning model, as will be described below.

FIG. 3B illustrates another flowchart of the method 300, showing the different boxes along with a conceptual representation thereof, according to an embodiment. As discussed above, historical data is received at 302. In some embodiments, this data may be partitioned section-wise at 304, and the trajectories may be normalized at 306. Parameters may then be extracted at 308. The trajectories may then be clustered at 310. In particular, as shown, the wells (or sections thereof) may be clustered according to trajectory at 310A and grouped in vector space at 310B. The vector space is conceptually represented in box 310B as two-dimensional; however, it will be appreciated that the vector space may have any number of dimensions.

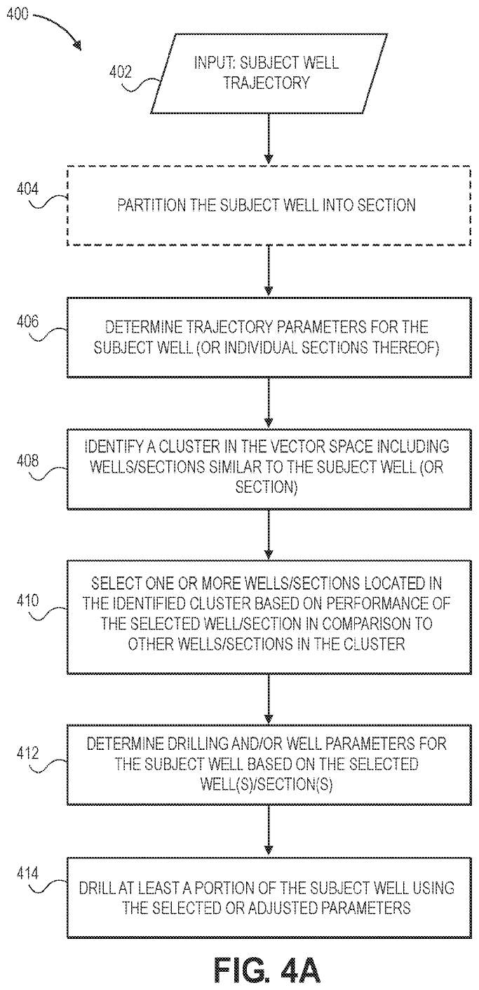

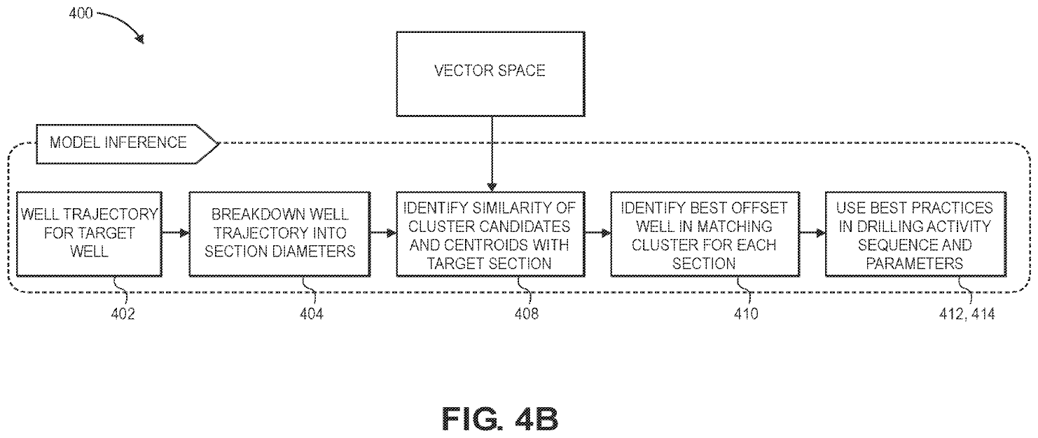

FIGS. 4A and 4B illustrate a flowchart of a method 400 for implementing a machine learning model, according to an embodiment. The method 400 may, for example, be an illustration of an embodiment of the implementation phase 204, as discussed above with reference to FIG. 2. In this embodiment, the method 400 may include receiving information representing a “subject” well, e.g., including trajectory information, potentially in addition to other information, parameters, equipment, drilling conditions, formation/rock properties, other settings, etc. The subject well may be a well that is being planned, e.g., may not have been started or may be started but incomplete.

In some embodiments, the method 400 may include partitioning the subject well into sections, as at 404. Such partitioning may be similar to the partitioning discussed above, such that similar sections in the historical and subject wells are compared. In other embodiments, the wells may not be partitioned but may be compared on a well-by-well basis. In still other embodiments, the sections and the overall wells may both be compared.

The method 400 may then include determining trajectory parameters for the subject well (or individual sections thereof), as at 406. This may also parallel the training stage, in which the trajectory parameters are extracted. The same or similar parameters may be extracted in the method 400, and may be employed to vectorize the data representing the subject well and/or one or more sections thereof. This may permit the machine learning model to plot the vectorized data representing the subject well (or section) in the vector space.

The method 400 may then include identifying a cluster in the vector space, as at 408. For example, the vectorized data representing the subject well (or section) may be plotted in the vector space using the machine learning model, which may then determine which (if any) cluster the subject well belongs in. By determining the cluster, the method 400 may thus permit the potentially very large dataset of offset wells to be reduced to a smaller subset, which may facilitate review and selection of one or more offset wells for extracting drilling practices, parameters, etc.

Accordingly, the method 400 may include selecting one or more wells (or sections, if partitioned) located in the identified cluster based on performance of the selected well/section in comparison to other wells/sections in the cluster, as at 410. In other words, the performance of the wells/sections in the cluster may be ranked, and one or more of the highest ranking selected. In some embodiments, a combination of similarity, even within a given cluster, may also be taken into consideration by the method 400. The ranking may take into consideration any number of performance-based factors, as mentioned above, including ROP, NPT, etc.

The method 400 may then include selecting or adjusting a drilling and/or well parameter for the subject well (or section thereof) based on the selected well/section, as at 412. For example, the selected, historical wells or sections may include a specification of drilling parameters that were used. The method 400 may thus include selecting or adjusting a drilling parameter, well parameter, etc., of the subject (in-plan) well based on the parameters of the selected wells or sections, e.g., to generate a similar performance as the selected historical well. Thus, the section or another portion of the well may then be drilled using the selected or adjusted parameter, as at 414. In at least some embodiments, data representing the one or more similar wells may be visualized, e.g., displayed on a computer display, which may illustrate one or more wells to the user, permitting the user to make parameter selections based at least in part on the displayed offset wells, selected using the machine learning model.

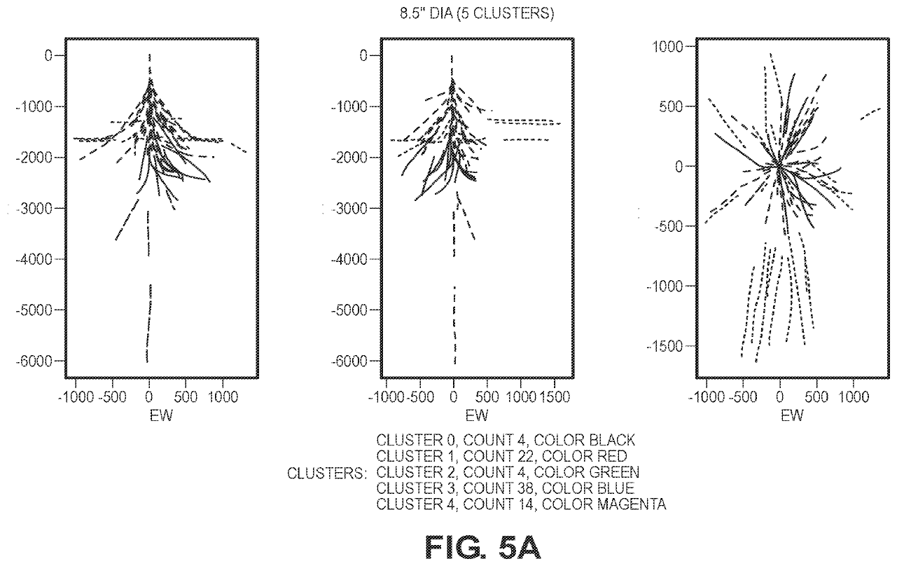

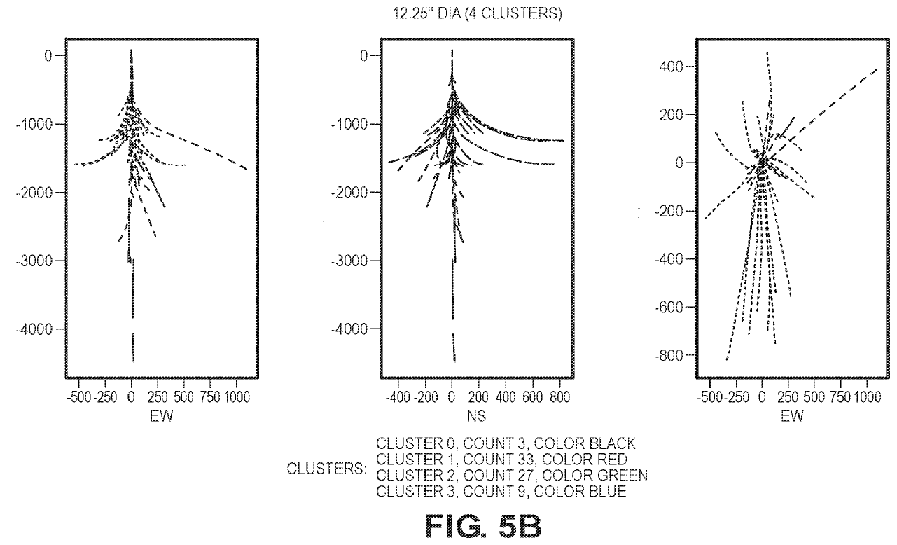

FIGS. 5A and 5B illustrate two examples of section clusters with normalized trajectories, according to an embodiment. As shown, the sections begin at the same point, and then vary in trajectory therefrom. These sections may be clustered, as shown, according to those with similar trajectories.

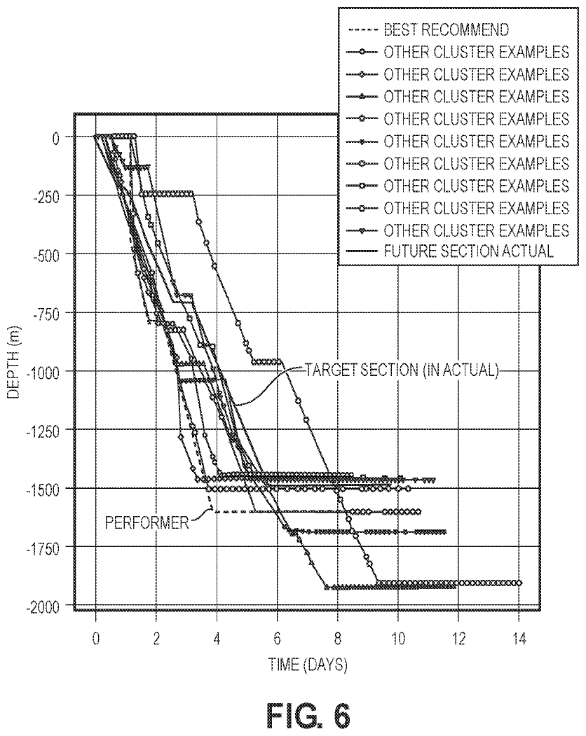

FIG. 6 illustrates a performance plot of the “best” performer from the cluster and the target section of the subject well, according to an embodiment. As shown, it may be desirable to more closely replicate the performance of the best performer, as the rate of penetration (depth over time) is greater for the best performer than the target section. Accordingly, the drilling parameters, etc., from the best performer may be employed as best practices and mimicked in the subject well.

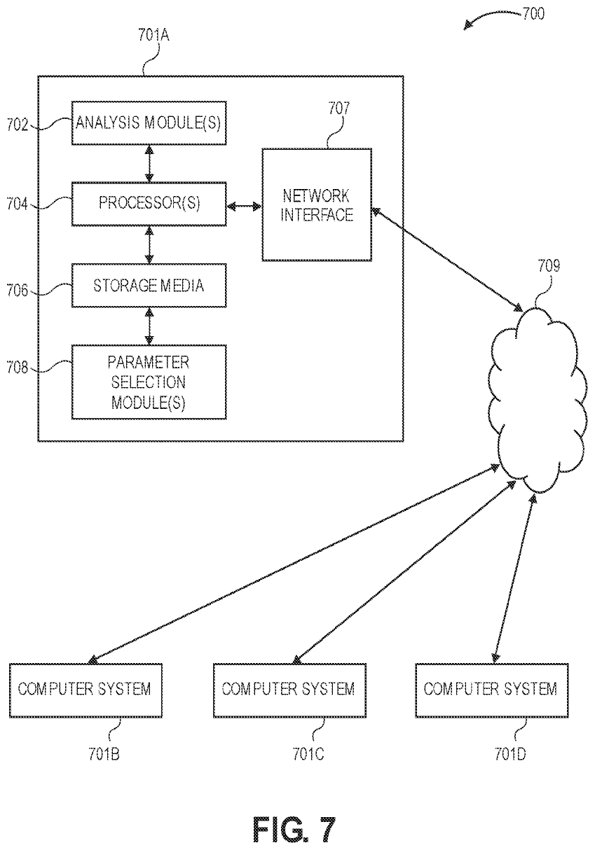

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 700 contains one or more parameter selection module(s) 708. In the example of computing system 700, computer system 701A includes the parameter selection module 708. In some embodiments, a single parameter selection module may be used to perform some aspects of one or more embodiments of the methods disclosed herein. In other embodiments, a plurality of parameter selection modules may be used to perform some aspects of methods herein.

It should be appreciated that computing system 700 is merely one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method, comprising:
receiving historical well data comprising trajectories, performance data, and one or more drilling parameters for a plurality of wells;
clustering at least a portion of the plurality of wells into a plurality of clusters based on the trajectories, using a machine learning model;
receiving trajectory data for a subject well;
identifying one of the clusters based on the trajectory data of the subject well, using the machine learning model;
selecting one or more of the plurality of wells, or one or more sections thereof, in the cluster that was identified based on the performance data associated with the one or more of the similar wells or the portion thereof; and
visualizing the selected one or more of the similar wells or one or more sections thereof.

2. The method of claim 1, further comprising adjusting a parameter for drilling the subject well based on the one or more drilling parameters associated with the selected one or more of the plurality of wells or the portion thereof.

3. The method of claim 1, wherein clustering the plurality of wells comprises normalizing the trajectories of the plurality of wells.

4. The method of claim 3, wherein normalizing comprises at least one of:
aligning north-south or east-west axes of the plurality of wells; or
aligning drilling trajectory along a vertical section azimuth.

5. The method of claim 3, wherein clustering the plurality of wells comprises extracting one or more trajectory parameters associated with each of the plurality of wells, after normalizing the trajectories.

6. The method of claim 5, wherein the one or more trajectory parameters comprise one or more of: XYZ coordinates, azimuth, elevation, depth, delta change in depth, or delta distance along an axis.

7. The method of claim 1, wherein the performance data comprises one or more of: rate of penetration, non-productive time, or drilling cost.

8. The method of claim 1, further comprising:
partitioning each of the plurality of wells into sections, each section comprising a finite, non-zero depth interval along one of the wells, wherein clustering the plurality of wells comprises clustering the individual sections of the plurality of wells based on the trajectories of the individual sections; and
partitioning the subject well into a plurality of sections, each section comprising a finite, non-zero depth interval long the subject well, wherein identifying the cluster comprises identifying a cluster for an individual section of the plurality of sections.

9. The method of claim 8, wherein the sections each define a different diameter of casing.

10. A non-transitory computer-readable medium storing instructions that, when executed by at least one processor of a computing system, cause the computing system to perform operations, the operations comprising:
receiving historical well data comprising trajectories, performance data, and one or more drilling parameters for a plurality of wells;
clustering at least a portion of the plurality of wells into a plurality of clusters based on the trajectories, using a machine learning model;
receiving trajectory data for a subject well;
identifying one of the clusters based on the trajectory data of the subject well, using the machine learning model;
selecting one or more of the plurality of wells, or one or more sections thereof, in the cluster that was identified based on the performance data associated with the one or more of the plurality of wells or the portion thereof; and
visualizing the selected one or more of the plurality of wells or one or more sections thereof.

11. The medium of claim 10, wherein the operations further comprise adjusting a parameter for drilling the subject well based on the one or more drilling parameters associated with the selected one or more of the plurality of wells or the portion thereof.

12. The medium of claim 10, wherein clustering the plurality of wells comprises normalizing the trajectories of the plurality of wells.

13. The medium of claim 12, wherein normalizing comprises at least one of:
aligning north-south or east-west axes of the plurality of wells; or
aligning drilling trajectory along a vertical section azimuth.

14. The medium of claim 12, wherein clustering the plurality of wells comprises extracting one or more trajectory parameters associated with each of the plurality of wells, after normalizing the trajectories.

15. The medium of claim 14, wherein the one or more trajectory parameters comprise one or more of: XYZ coordinates, azimuth, elevation, depth, delta change in depth, or delta distance along an axis, and wherein the performance data comprises one or more of: rate of penetration, non-productive time, or drilling cost.

16. The medium of claim 10, wherein the operations further comprise:
partitioning each of the plurality of wells into sections, each section comprising a finite, non-zero depth interval along one of the wells, wherein clustering the plurality of wells comprises clustering the individual sections of the plurality of wells based on the trajectories of the individual sections; and
partitioning the subject well into a plurality of sections, each section comprising a finite, non-zero depth interval long the subject well, wherein identifying the cluster comprises identifying a cluster for an individual section of the plurality of sections.

17. A computing system, comprising:
one or more processors; and
a memory system comprising one or more non-transitory computer-readable media storing instructions that, when executed by at least one of the one or more processors, cause the computing system to perform operations, the operations comprising:
receiving historical well data comprising trajectories, performance data, and one or more drilling parameters for a plurality of wells;
clustering at least a portion of the plurality of wells into a plurality of clusters based on the trajectories, using a machine learning model;
receiving trajectory data for a subject well;
identifying one of the clusters based on the trajectory data of the subject well, using the machine learning model;
selecting one or more of the plurality of wells, or one or more sections thereof, in the cluster that was identified based on the performance data associated with the one or more of the plurality of wells or the portion thereof; and
visualizing the selected one or more of the plurality of wells or one or more sections thereof.

18. The computing system of claim 17, wherein the operations further comprise adjusting a parameter for drilling the subject well based on the one or more drilling parameters associated with the selected one or more of the plurality of wells or the portion thereof.

19. The computing system of claim 17, wherein clustering the plurality of wells comprises normalizing the trajectories of the plurality of wells, wherein normalizing comprises at least one of aligning north-south or east-west axes of the plurality of wells, or aligning drilling trajectory along a vertical section azimuth.

20. The computing system of claim 17, wherein the operations further comprise:
partitioning each of the plurality of wells into sections, each section comprising a finite, non-zero depth interval along one of the wells, wherein clustering the plurality of wells comprises clustering the individual sections of the plurality of wells based on the trajectories of the individual sections; and
partitioning the subject well into a plurality of sections, each section comprising a finite, non-zero depth interval long the subject well, wherein identifying the cluster comprises identifying a cluster for an individual section of the plurality of sections.
